(19) United States
(12) Patent Application Publication
(10) Pub. No.: US 2004/0050924 A1
(43) Pub. Date: Mar. 18, 2004

(54) Enabling of devices

(76) Inventors: Falk Mletzko, Munchen (DE); Susanne Pudlitz, Mering (DE); Manfred Schacht, Munchen (DE)

Correspondence Address: BELL, BOYD & LLOYD, LLC, P. O. BOX 1135, CHICAGO, IL, 60690-1135, US

(21) Appl. No.: 10/433,755

(22) PCT Filed: Nov. 22, 2001
(86) PCT No.: PCT/EP01/13636

(30) Foreign Application Priority Data
Dec. 6, 2000 (EP) 00126804.4

(51) Int. Cl. G06F 17/00

(52) U.S. Cl. 235/375

(57) ABSTRACT

The invention relates to a method for enabling interconnectable terminals used in data processing and/or communication technology. According to the invention, an enabling action is carried out on a terminal, then an enabling message is transmitted to at least one other terminal.

The invention relates to a method for enabling devices that can be interconnected.

An enabling method of this type should be taken to mean the authentication of a user to a device. The authentication can be effected by entry of a personal identification number (PIN), generally consisting of alphanumeric characters, or also by input of a fingerprint via a so-called fingerprint sensor. The authentication can also be accomplished by means of other biometric patterns, for example voice or iris.

Devices should be taken to mean stationary or mobile terminal devices used in data processing, such as PCs, notebooks or palmtops and PDAs (Personal Digital Assistants), and stationary or mobile terminal devices used in communications technology. Many people use both a mobile radio device, a so-called mobile phone or handset, and a PDA. Each of these two devices is protected by its own security password and must be individually unlocked by entering the corresponding password or biometric pattern.

The object of the invention is to specify a convenient method for enabling a number of devices.

This object is achieved according to the invention by the features recited in claim 1.

In an exemplary embodiment of the invention there are two devices, a mobile radio device and a palmtop for example,. In order to exchange data, the two devices can be interconnected via an infrared interface.

The data communication between devices of this type can be effected via infrared, Bluetooth, an RF connection or also via a cable.

In order to execute the method according to the invention, a suitable enabling action is performed on one of the devices, for example the mobile radio device. Toward that end, the normally provided four-digit code number, for example, is entered via the keypad. As already explained in the introductory remarks, the input of a fingerprint may also be used instead. Furthermore, an analysis of the user's voice is also conceivable as part of an additional biometric recognition.

An enabling message is then transmitted by the mobile radio device to the palmtop via the wireless or wired communications connection. A prerequisite for this is that at least the infrared interface on the palmtop is in an operational state before the device is enabled. This is generally the case, however, since the password prompt is issued only after the device is switched on, the communications interface already being activated.

As already explained, the device can be enabled by entry of a numeric code. For increased security provision may be made for both devices to prompt for the user stored in each device. In the method according to the invention, when a password is entered correctly on a device, for example the mobile radio device, the second device, such as the palmtop in this case, is enabled automatically; further devices may also be enabled in the same way. This frees the user from the tedious and time-consuming task of keying in passwords and also removes the need to remember two passwords.

In one embodiment of the invention, the data acquired during the enabling action is transferred during the transmission of the enabling message. As a result of this, the other device, such as the palmtop in this case, can independently perform a further check.

Particularly in the case of the pico networks provided within the Bluetooth environment, a prompt can also be issued by a device that comes into the range of the devices that make up the pico network. In this case there is then no longer any need for explicit action on the part of the user, since the additional device is enabled automatically. From the legitimate use of the existing devices, the use of the additional device is also enabled, provided there is, for example, a common owner or user.

In order to execute the method according to the invention, a further activated device is necessary, to which the enabling message can be sent via an active interface. It is also possible, on the initiative of the first device, the mobile phone or handset, to switch on the further device or devices automatically and thereby initiate the transfer to the interface.

1. Method for enabling interconnectable terminal devices used in data processing and/or communications technology,
wherein an enabling action is performed on one terminal device, and
wherein an enabling message is subsequently transmitted to at least one further terminal device.

2. Method according to claim 1,
wherein the enabling message contains the data acquired during the enabling action.

3. Method according to claim 1 or 2,
wherein a prompt for an enabling message is automatically issued by one of the further terminal devices.
